(19) United States
(12) Patent Application Publication
(10) Pub. No.: US 2020/0034803 A1
(43) Pub. Date: Jan. 30, 2020

(54) System and Method for Providing Services and Goods

(71) Applicant: More Than Sumpathy, LLC, Austin, TX (US)

(72) Inventor: Naomi Bourgeois, Austin, TX (US)

(21) Appl. No.: 16/521,357

(22) Filed: Jul. 24, 2019

Related U.S. Application Data
(60) Provisional application No. 62/702,741, filed on Jul. 24, 2018.

(51) Int. Cl. G06Q 20/06; G06Q 30/06

(52) U.S. Cl. CPC G06Q 20/065; G06Q 30/0633

(57) ABSTRACT

A system and method is provided that allows givers to purchase redeemable points as gifts for specified recipients. The points may then be used by the recipient to receive goods and/or services from an available set of goods and services for various goods and services providers. The available goods and services can include meal and food delivery, housing keeping services, lawn care service, and concierge, among others. The system and method automates the steps and processes for contributing points to a recipient as a gift, searching available goods and services and redeeming goods and services when desired by the recipient and at a location desired by the recipient.

### FIELD OF THE INVENTION

The present invention relates generally to the field of systems and methods whereby goods and/or services may be distributed among a wide network of persons in a coordinated fashion, and according to the needs of a recipient.

### BACKGROUND OF THE INVENTION

There are many times when people want to send a practical gift to a friend, family member, coworker or other person, especially if that person is going through a challenging situation such as death, sickness, divorce or maternity. However, providing such a gift can be difficult because of uncertainty as to what the person needs or wants, the uncertainty of coordinating logistics and the limited amount of time to help.

During difficult times, persons in the form of givers or contributors often come together at the onset of a situation to help the recipient or person in need, but it is common for the recipient to not know what help they need as they are processing and dealing with the situation at hand. It is also common for the recipient to be mentally, emotionally, and/or physically exhausted, thus, making it difficult for them to make decisions, deal with the requests of others, or coordinate services that would have been otherwise easier to do. After a while, when the recipient has had enough time to get control of the situation and knows what help they need or want, the givers have moved on with their normal lives. Many recipients are also unwilling or embarrassed to ask for help at this time. As a result, the givers who want to provide help or assistance to a recipient in need are unable to do so, and recipients who need help and assistance during difficult times are unable to receive the help and assistance they need, even though many givers have a desire to help.

Currently, systems exist that enable persons to access a platform or system, select specific goods and/or services and purchase the selected goods and/or services for another person in the form of a specific gift and/or gift card redeemable for a limited selection of merchandise and/or services. In most cases, these types of systems require the contributing person to identify the particular good or service, purchase the good/service or a redeemable voucher for it, and limit the receiving person to receiving the identified specific good or service from the contributing person. In this situation, the contributing person and/or giver is challenged with having to decide what is best to select for the recipient. Similarly, the recipient is challenged with having to decide what to request from a contributing person and/or giver, as well as determining if he/she is able to utilize the particular gift being selected in their particular circumstance. As a result, the difficulties in providing the intended assistance and support to a recipient in need continue to exist.

Accordingly, a need continues to exists for a method and system to facilitate the interactions between givers and recipients in need with a funding system whereby a wide variety of goods/services may be made available by a giver/contributor to an intended recipient, that would accommodate the diverse potential needs of the recipient, and that is accessible to the recipient over a period of time during his/her recuperation and/or readjustment.

### SUMMARY OF THE INVENTION

The present invention relates generally to a system and method for funding and distributing services and goods to recipients. The present invention is also directed to a system and method that allows givers (such as friends, family, coworkers, the general community and other persons) to purchase “points” or “credits” as gifts for a recipient. The points purchased by a giver can be archived, maintained or otherwise stored in an account for the recipient and the recipient can subsequently redeemed and/or used to purchase goods and services desired by the recipient at a time and location desired by the recipient, over a reasonable period of time.

The system and method of the present invention can provide the capabilities for a giver to purchase points as a gift to a recipient that the recipient can then use to obtain goods and services. The recipient is thus allowed to decide what goods and services would be most beneficial, as well as when and where these goods and/or services would be most beneficial for the recipient. The system and method of the present invention can also enable recipients to purchase points for themselves to obtain additional goods and services.

The present invention can provide the advantage of facilitating the coordination of the goods and services for the recipient, which during challenging situations, allows the recipient to use his or her energy and time on matters that cannot be delegated. The present invention can further enable givers to provide a meaningful gift by purchasing points for a recipient when it is fresher in mind and the recipient can bank on the goodwill without needing to decide on how to use the points immediately. The points can be used by the recipient at any time when they know what they need and/or when they actually need the help.

The present invention can additionally have many other applications and benefits. For example, there are times when family members want to help an elderly parent or family member who resides in a different location, but such family members do not have time to find a service provider, do not know a provider to trust, or are unable to coordinate a service directly. The system and method of the present invention can be utilized to enable the family member to create an account for themselves as a recipient and coordinate the goods and services through the system to be delivered to the other family member in need.

The system and method of the present invention can include a social component that can enable recipients to interact with their givers or other recipients who are going through similar situations and/or within a certain geographic proximity. Support groups may be formed through the system of the present invention connecting a network of users of the system.

The system and method of the present invention can include an educational component where links to informational sites, webinars, videos, conferences, and resources that can help both recipients and givers.

The system and method of the present invention can include a charitable component that can enable givers to donate or contribute to non-profit organizations and charitable organizations, both generally and during national crisis. The charitable component can also enable recipients to use points received by givers to make donations to such organizations.

Other aspects and advantages of the present invention will be apparent from the following detailed description of the preferred embodiments of the accompanying drawing figures.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a schematic diagram view of a system for facilitating the provision of goods and services as gifts in accordance with one embodiment of the present invention;

FIG. 2 is a schematic diagram view of an account creation module included as part of the system of FIG. 1;

FIG. 3 is a schematic diagram view of a contribution module included as part of the system of FIG. 1;

FIG. 4 is a schematic diagram view of a recipient sharing module included as part of the system of FIG. 1;

FIG. 5 is a schematic diagram view of a recipient dashboard module included as part of the system of FIG. 1;

FIG. 6 is a schematic diagram view of a redemption module included as part of the system of FIG. 1;

FIG. 7 is a schematic diagram view of a fulfillment module included as part of the system of FIG. 1;

FIG. 8 is a schematic flow chart of a method for enabling the purchase and redemption of goods and services as a gift in accordance with one embodiment of the present invention;

FIG. 9 is a schematic flow chart of a method for enabling the purchase and redemption of goods and services as a gift in accordance with one embodiment of the present invention; and

FIG. 10 is a schematic diagram view of a system for facilitating the provision of goods and services as gifts in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The present invention is directed to a system 100 and method 200 for facilitating the funding, purchase, distribution and use of goods and services between users in the form of givers and recipients. System 100 and method 200 can incorporate processes and capabilities that can enable giver-users to purchase gifts for selected recipient-users in the form of points or tokens which are then stored in connection with the selected recipient-user's account. In certain embodiments of the present invention, system 100 and method 200 can be configured to enable giver-users to contribute money or cash to the selected recipient-user's account in addition to or alternatively from points or tokens. System 100 and method 200 can further incorporate processes and capabilities to then enable recipient-users to use or redeem the points in the recipient-user's account to purchase and receive various goods and services at a time desirable by the recipient-user. The available goods and services can be provided through a user platform incorporated with system 100 and method 200 and can be any suitable types of goods and services, including but not limited to, concierge, meal delivery, lawn care, insurance, financial, legal, house cleaning, maintenance and repairs, transportation, organizing, child care, senior care, an any other desired types of services. In addition, depending on the particular embodiment, the available goods and services can vary based on geographic location. System 100 and method 200 can be further configured to facilitate, coordinate and automate the entire transaction between a giver-user and a recipient-user by providing a platform that allows giver-users to make gift contributions, recipient-users to use the gift contributions to purchase goods and services, and service providers to fulfill order requests for goods and services.

In certain embodiments of the present invention, a giver-user may deposit money directly into a recipient-user's account (as opposed to or in connection with purchasing points), which can then be used by the recipient-user to purchase goods/services and/or can be directly withdrawn from the recipient-user's account. The description provided herein refers to “points” merely for clarity and convenience, however, it is recognized that money, cash or other form of value can additionally or alternatively be used with or in place of the “points” in connection with system 100 and method 200.

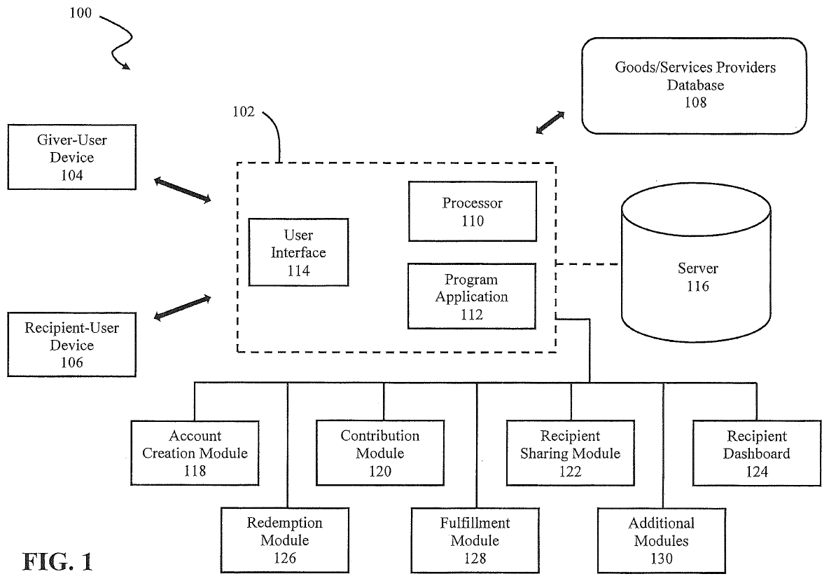

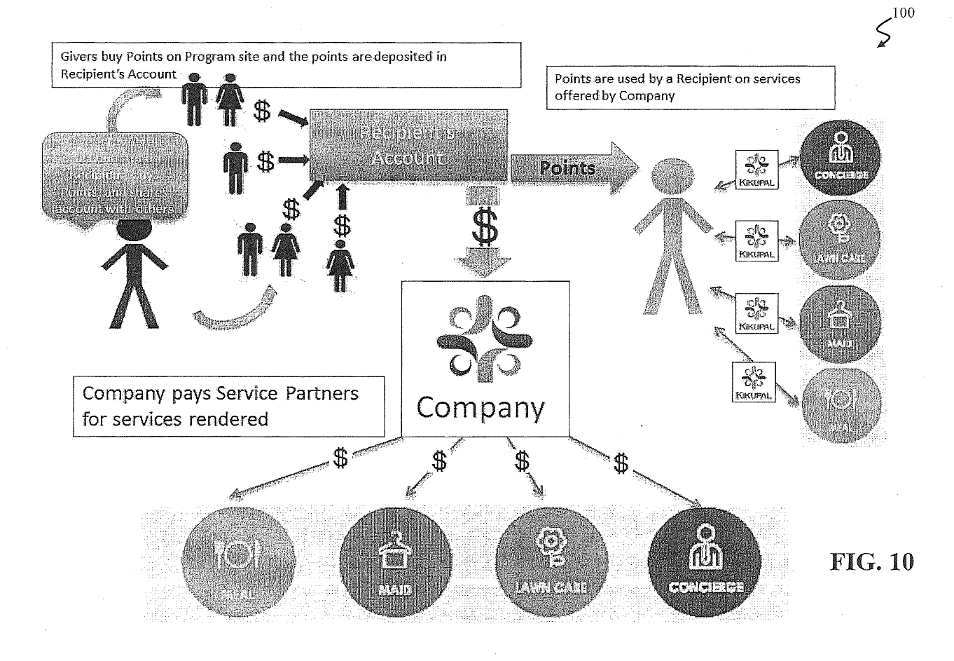

Referring to FIGS. 1-7 (and FIG. 10), system 100 of the present invention is illustrated schematically according to one embodiment. As shown in FIG. 1, system 100 can include a network computing system 102 configured to operate system 100, send, receive, transmit information and communicate with giver-user devices 104, recipient-user devices 106 and goods and services providers. Computing system 102 can further be configured to communicate and query a goods/services provider database 108 having goods and services offerings from a plurality of goods and services providers. Computing system 102 may be configured as any suitable computing system and may include a processing component 110 and a program application 112. Processing component 110 can be configured as any suitable type of computer processor configured for carrying out one or more sets of programming instructions and sending, receiving, processing and/or storing various types of data and information. Program application 112 may be an application with programming instructions, that when executed by processing component 110, cause system 100 to carry out one or more steps and/or procedures for sending, receiving and/or storing various types of data and information described herein and instructing the operation of one or more modules and submodules of system 100. Computing system 102 can additionally include a program website and one or more user interfaces 114 that are operated by program application 112 and enable interaction with user devices 104 and 106 to send and receive data and information and access system 100. Program website and user interfaces 114 may be collectively configured as part of a user-system platform 114 accessible to users via the Internet in order to enable users to access and utilize system 100. System 100 can additionally include one or more servers/databases 116 in communication with processing component 110 and program application 112 for storing data information received, generated and utilized by system 100.

System 100 can be utilized by users to purchase points through a user device 104 or 106 connected to system 100 and then can provide the points as a gift to other users or themselves. Users can further use system 100 to access an account associated with the user through a user device 104, 106 connected to system 100, view the user's point total, use the user's points to purchase goods and services available through system 100 from available goods and services providers database 108 and perform other actions or functions. System 100 can be configured to control and operate transactions and interactions from users connecting to system 100 through a user device 104, 106 and receive, store and transmit user data and information in order to facilitate interactions between users and system 100.

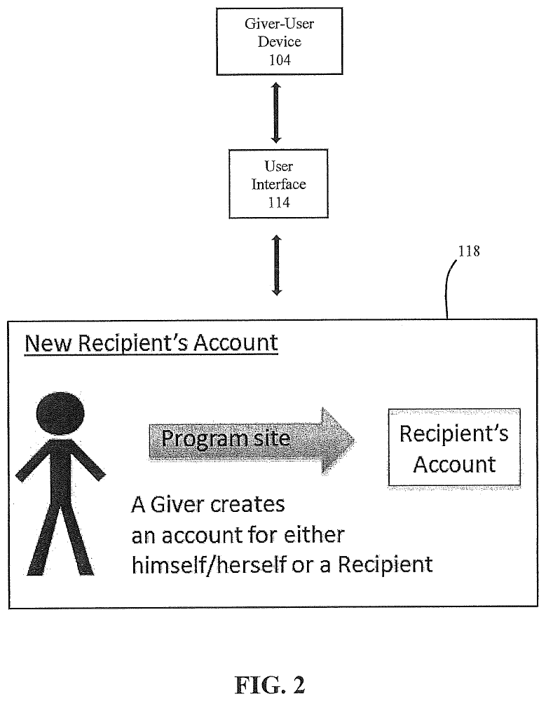

As shown in FIGS. 1 and 2, system 100 can include an account creation module 118 incorporated with program application 112 to enable giver-users to create an account for a recipient-user or themselves. Account creation module 118 can operate through the program website and graphical interface 114 of system 100 to display the operation of system 100 and module 118 on a user device 104/106 associated with the user. The account creation module 118 can be configured to receive recipient information from a user to associate with a user account for the recipient. This information can include name, email address, address, telephone number, or any other desired information. The account creation module 118 can then check system 100 to determine whether the entered information matches the information for an existing user (either giver-user or recipient-user) account. If the entered information matches an existing user account, then the account creation module 118 can ask the user to verify the account or provide new user information. If the entered information does not match an existing user account, the account creation module 118 can create a new account and associate the entered information with the new account. After a new account is created, the account creation module 118 can then send a notification to both the giver-user and the recipient-user to let each know that the new account for the recipient-user was created using the entered information.

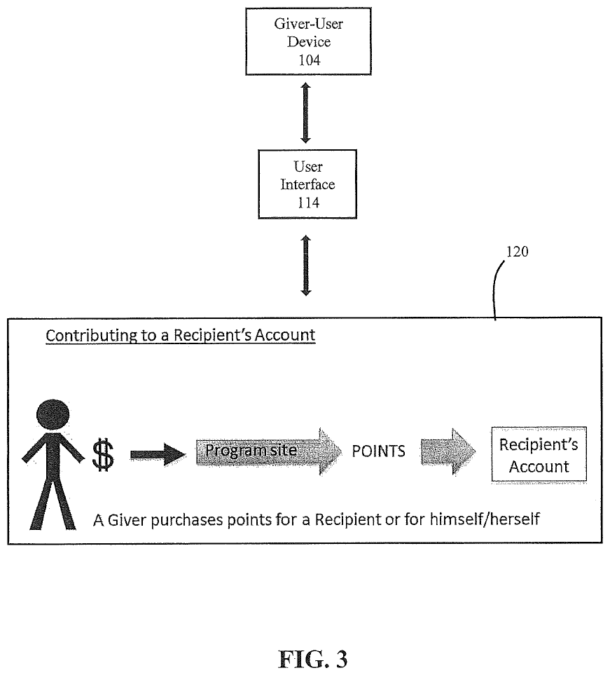

As shown in FIGS. 1 and 3, system 100 can include an account contribution (or giving) module 120 incorporated with program application 112 to enable a giver-user to purchase and give points to a recipient-user as a gift, where the points are deposited in the recipient-user's account. Account contribution module 120 can additionally be configured to enable giver-users and recipient-users to purchase points for their own accounts. Account contribution module 120 can operate through the program website and graphical user interface 114 (i.e., user platform 114) of system 100 to display the operation of system 100 and module 120 on a user device 104 associated with the user. After a giver-user has created an account for a recipient-user, or otherwise verified an existing account for a recipient-user, account contribution module 120 can allow the giver-user to either select an amount of points to purchase or provide a dollar amount for which to purchase points as a gift for the recipient-user. After the giver-user has selected the dollar or point amount, the account contribution module 120 updates the recipient-user's account to reflect the amount of points purchased by the giver-user. The account contribution module 120 can also allow the giver-user various additional options in association with the point-gift purchase. Such additional options can include, but are not limited to, whether to contribute the point-gift anonymously, and whether to include a note to the recipient-user.

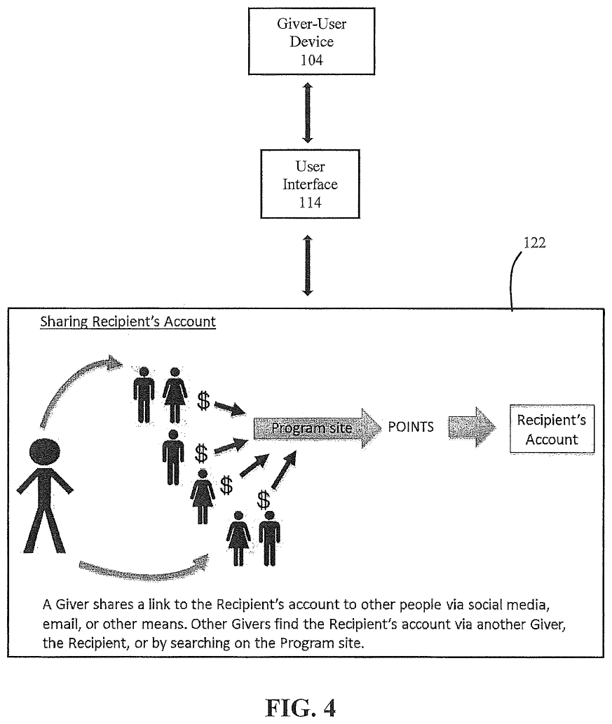

As shown in FIGS. 1 and 4, system 100 can include a recipient sharing module 122 incorporated with program application 112 to enable a giver-user to share a link to a recipient-user's account with other potential giver-users via social medial, email or other means. The recipient sharing module 122 can operate through the program website and graphical interface 114 of system 100 to display the operation of system 100 and module 122 on a user device 104 associated with the user. After a user makes a contribution to a recipient-user's account by purchasing points for the recipient-user associated with the account through the account contribution module 120 (or after creating a new account for a recipient-user or otherwise identifying an account of an existing recipient-user), the recipient sharing module 122 can prompt the giver-user through user interface 114 and provide the giver-user with the option to share the recipient-user's account with others. If the giver-user elects to share the recipient-user's account, the recipient sharing module 122 can be configured to create a link for the giver-user to share with others via social media, email or other means. The potential giver-users can the utilize the shared link to connect to the program website and user interface 114 to access the recipient-user's account and purchase points for the recipient-user as a gift through system 100. In addition, potential giver-users can connect to program application 112 through program website and user interface 114 and search the recipient-user to identify the recipient-user's account.

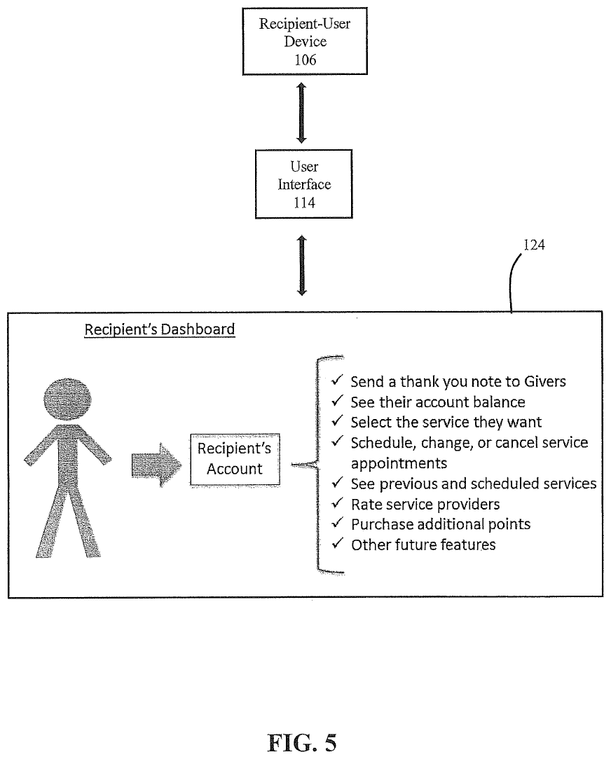

As shown in FIGS. 1 and 5, system 100 can include a recipient dashboard module 124 incorporated with program application 112 to enable a recipient-user to access the recipient-user's account and perform various tasks. The recipient dashboard module 124 can operate through the program website and graphical interface 114 of system 100 to display the operation of system 100 and module 124 on a user device 106 associated with the recipient-user. As described above, once a recipient-user account is created, the recipient-user associated with the account will be sent a notification by system 100 and enable the recipient-user to connect to system 100 through program website and user interface 114 and access the recipient-user's account through the recipient dashboard module 124. Once accessed by the recipient-user, the recipient dashboard module 124 can be configured to allow the recipient-user to check the balance of points in the recipient-user's account, view the giver-users who contributed points to the recipient-user's account, and purchase additional points through the system 100. Recipient dashboard module 124 can also be configured with capabilities allowing the recipient-user to send thank you notes to giver-users, view pending and previous goods/services purchases, cancel or change pending goods/services purchases, rate goods/services providers for previously purchased goods/services, access the redemption module 126 (described below) to view goods/services for purchase with points along with other suitable tasks.

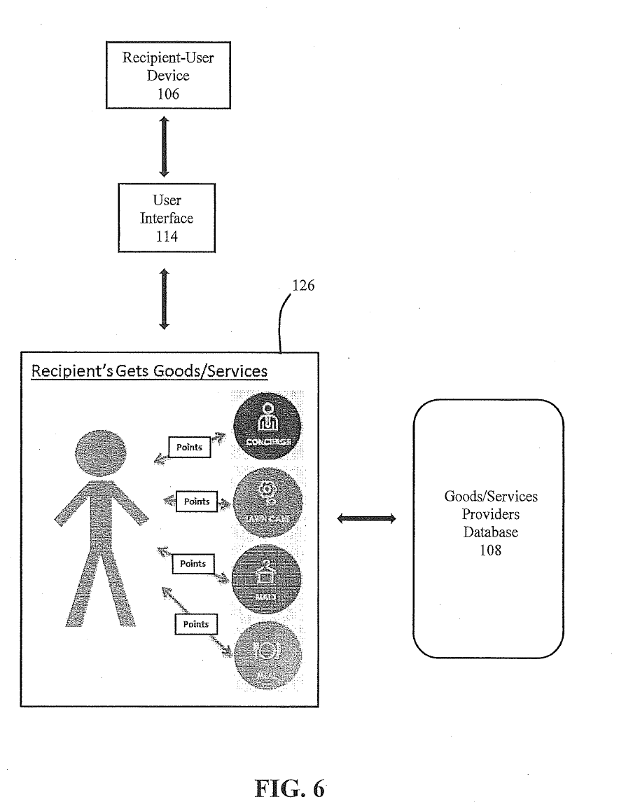

As shown in FIGS. 1 and 6, system 100 can include a redemption module 126 incorporated with program application 112 to enable a recipient-user to view and purchase goods and services offered through system 100 in connection with various goods and services providers. The redemption module 126 can operate through the program website and user interface 114 of system 100 to display the operation of system 100 and module 126 on a user device 106 associated with the recipient-user. Redemption module 126 can be accessed by recipient-users through the recipient-user's account and recipient dashboard module 124. Redemption module 126 can be configured to display various types of goods and services available for the recipient-user to purchase using the recipient-user's points. The available goods and services can be displayed, sorted and searched based on any suitable category, including but not limited to type, location, estimated point amount, and/or provider. Once the recipient-user makes a goods/services request, system 100 can be configured to carry out the request and update the recipient-user's account accordingly. Redemption module 126 can also be configured to request entry of additional information from the recipient-user, depending on the particular type of goods or services, relating to the goods or services in order to enable system 100 to fulfill and coordinate the provision of the goods or services to the recipient-user. For example, meals and food-related goods or services requested, redemption module 126 can require the recipient-user to provide information such as delivery date and time and delivery address; for cleaning services or lawn care services, redemption module 126 can required number of rooms, lawn size, etc.

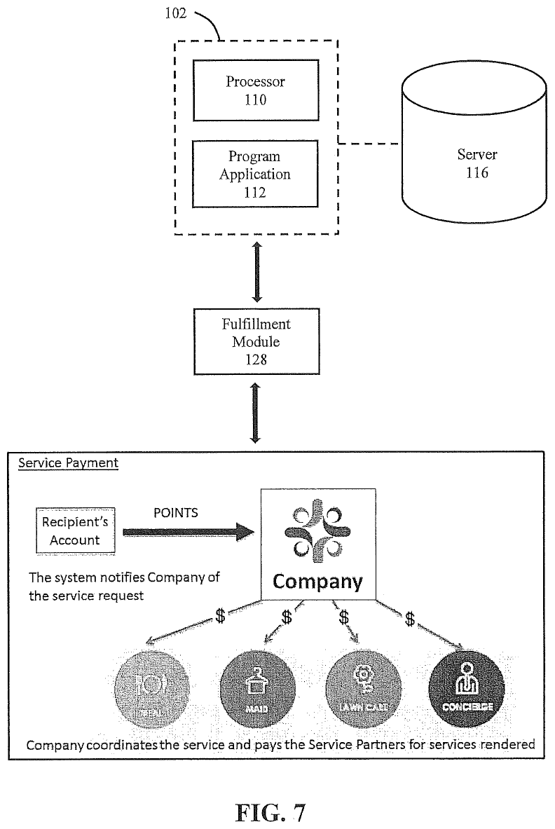

As shown in FIGS. 1 and 7, system 100 can include a fulfillment module 128 incorporated with program application 112 to enable system 100 to coordinate and fulfill a goods/services request made by a recipient-user through system 100. After a recipient-user completes a goods/services request through recipient dashboard 124 and redemption module 126, fulfillment module 128 can be configured to identify the corresponding goods/services provider (via database 108), send the request for services to the identified goods/services provider, track the confirmation and acceptance of the request, track the fulfillment of the request and submit payment upon completion of the goods/services.

As further shown in FIG. 1, system 100 can also include one or more additional modules 130 for providing various different features, capabilities and options for the giver-users and recipient-users of system 100. According to one embodiment, additional modules 130 can include a social networking module that can enable recipient-users to interact with giver-users who provided gifts or other recipient-users who are going through similar situations or are located within a certain geographic proximity through message boards, support groups and other networks provided through the program website and user interfaces 114. According to another embodiment, additional modules 130 can include an educational module accessible through the program website and user interfaces 114 that can enable giver-users and recipient-users to be directed to and/or view informational sites, webinars, videos, conferences and resources. According to another embodiment, additional modules 130 can include a charitable contribution module accessible through the program website and user interfaces 114 that can enable giver-users and recipient-users to donate to non-profit organizations and other charitable organizations, both generally and during national crisis.

According to one embodiment, system 100 (via an additional module 130 or otherwise) can be configured to require points deposited or stored into a recipient-user's account to be used or redeemed within a certain time period, and if such points are not used within a specified time period from being deposited, then such points can be transferred to a separate account maintained by the operator-company of system 100. For example, according to one embodiment, system 100 can be configured such that any points deposited into a recipient-user's account and not used within 22 months of being deposited can be deemed expired and transferred from the recipient-user's account into a separately held community expired point account. According to one embodiment, any time period less than two years may be used. According other embodiments, any suitable time period (e.g., 1 year, 2, years, 3 years, 5 years, 10 years, etc.) can be used. System 100 can further be configured to enable recipient-users to reactivate their account after the designated period of time has elapsed and reclaim lost points, which can be transferred from the administrative account back into the recipient user's account, less an administrative maintenance fee of any suitable type. According to one embodiment, in the event points are transferred from a recipient-user's account to the administrative account as a result of non-use in the designated time period, a “donation receipt” can automatically be generated and sent to the recipient-user regarding the points transferred from the recipient-user's account to the administrative account. The deactivation time period can be implemented to comply with requirements and/or regulations set forth by a governing body or agency, can be implemented in order to facilitate accounting procedures and management, and/or to otherwise facilitate the operation of system 100.

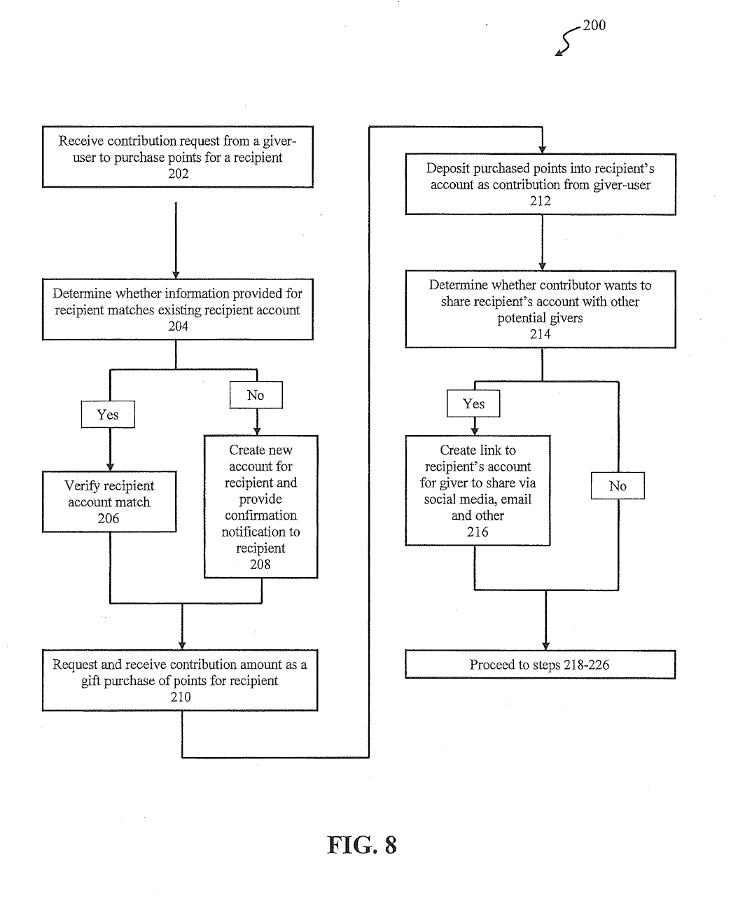

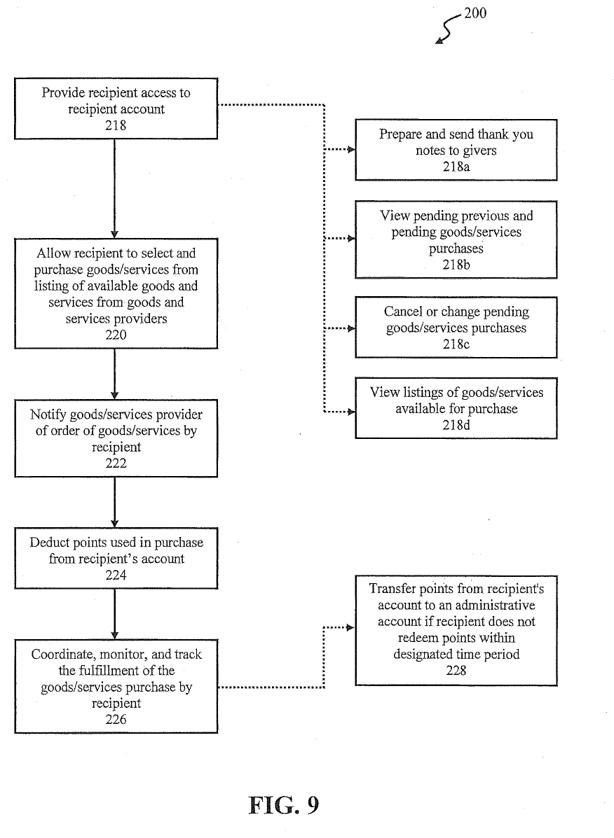

Turning now to FIGS. 8 and 9, method or process 200 (associated with system 100) is shown schematically and described in greater detail. As shown in FIGS. 8 and 9, method 200 can be configured as a process or method for facilitating users to provide goods and/or services to others through a point gifting and redemption process. As described above, method 200 (and system 100) enables a giver-user to contribute points to a specific recipient-user in a manner that allows the recipient-user to redeem the points for goods and/or services desired by the recipient-user at the time desired by the recipient-user. Method 200 further enables giver-users to provide a gift to a recipient-user while still allowing the recipient-user to select the particular goods or services for the gift and the time and place for the gift. FIG. 8 illustrates the giver-user component of method 200 while FIG. 9 illustrates the recipient-user component of method 200.

As shown schematically in FIG. 8, method 200 can include series of steps or components for easily enabling giver-users initiate a gift transaction and purchase points for a recipient-user such that the points can subsequently be used by the recipient-user to obtain goods and/or services of their choosing (shown schematically in FIG. 9 where method 200 can enable the recipient-user to utilize points received as one or more gifts and purchase goods and/or services). As described above, depending on the particular embodiment of the present invention, method 200 can be carried out by a user interactive platform and system that can incorporate a program website that can be displayed and utilized though user devices.

As shown in FIG. 8, method 200 for facilitating the provision of a gift to a recipient can begin at a step 202 where a contribution request from a giver-user is received to make a gift contribution to a particular recipient-user. During step 202, the giver-user can provide identifying and contact information (e.g., email address, name, etc.) to enable the identification of the recipient-user. Next, at step 204, the provided information for the recipient-user can be checked to determine whether the provided information matches an existing recipient-user. If a match to an existing recipient-user is identified, then method 200 can proceed to step 206 where the giver-receiver can verify the recipient-user matched during step 204. If there is no identified match at step 204, then method 200 can proceed to step 208 where a new account for the recipient-user is created and a confirmation notification is sent to the new recipient-user using the provided information.

Next, at step 210, the giver-user can purchase points for the recipient-user as a gift. If the giver user-elects to purchase points for the recipient-user, then the points are added to the recipient-user's account at step 212. Next, at step 214, the giver-user can select to share the recipient-user's account with other potential givers. If the giver-user selects to share the recipient-user's account, a link can be created for the giver-user to copy and share via social media, email or other communication means at step 216. Following step 216, method 200 can proceed to steps 218-226 where the recipient-user can access his/her account and redeem points for various goods and services from good/services providers.

As shown in FIG. 9, method 200 can include a step 218 where a recipient-user can access the recipient-account to view the amount of points that the recipient-user has received as gifts from one or more giver-users. During step 218, the recipient-user can perform various functions and tasks, including send thank you notes to giver-users (218a), view pending and previous goods and services purchased (218b), cancel or change goods and services purchases (218c), view listings of potential goods and services (218d).

As further shown in FIG. 9, method 200 can also include a step 220 where the recipient-user can use the points in his/her account to obtain goods and/or services. During step 220, recipient-user can view and/or search through various goods and services offered by various goods and services providers and select one or more goods and/or services based on the preferences of the recipient-user. During step 220, the recipient-user can select one or more options in connection with the goods and/or services, such as delivery date and location, and other features associated with the redemption of the goods and/or services. Following the selection of a particular goods and/or services, at step 222 the goods/services provider(s) corresponding to the selected goods and/or services are notified. Then at step 224, the points used to obtain the goods and/or services are deducted from the recipient-user's account. Then at step 226, the goods and/or services are provided to the recipient-user in the manner indicated by the recipient-user and the goods and/or services order is coordinated, monitored and tracked to ensure fulfillment of the service.

According to one embodiment, method 200 can also include a step 228 whereby any points deposited into a recipient-user's account and not used/redeemed within a specified time period (e.g., 22 months from date of deposit) are automatically deposited into a separate administrative account held by the system operator. According to one embodiment, the specified time period can be any time period less than two years; however, it is recognized that any suitable or desired time period may be used. In addition, method 200 can include a subsequent step 230 whereby upon request from a recipient-user, “deactivated” points transferred into the administrative account upon lapse of the designated time period are transferred back to the recipient-user's account (less an administrative fee). As described above, the “deactivation” time period can be implemented to comply with requirements and/or regulations set forth by a governing body or agency, can be implemented in order to facilitate accounting procedures and management, and/or to otherwise facilitate functionality of method 200.

Collectively, the steps of method 200 enable giver-users to initiate and provide a contribution to a recipient-user as a gift in the form of points. The giver-user can create an account for the recipient-user, purchase points to deposit into the account and invite others to purchase points to contribute to the recipient-user's account. Once a recipient-user account has been created, the method 200 enables the recipient-user to access the account, view available goods and services from various goods and services providers and purchase goods and services through an online platform. Once the recipient-user completes a service request, method 200 automates and facilitates the fulfillment of the transaction by carrying out a series of steps where the service provider for the purchased goods or services is notified, the required information to complete the transaction of provided to the provider, the completion of the transition is monitored and the provider is paid for the goods or services.

From the foregoing, it will be seen that this invention is one well adapted to attain all the ends and objects hereinabove set forth together with other, advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A system for facilitating the purchase and distribution of goods and services between a giver-user and a recipient-user, said system comprising:
a program website and a user interface configured for displaying information to said giver-user and recipient-user;
a program application comprising instructions tangibly stored on a computer-readable medium and executed by a computer processor to perform one or more steps;
an account creation module configured for enabling said giver-user to create a recipient account for one of said recipient-user;
a contribution module configured for enabling said giver-user to purchase points to be deposited in said recipient account;
a recipient sharing module configured for enabling said giver-user to share said recipient account with another giver-user;
a recipient dashboard module configured for enabling said recipient-user associated with said recipient account to view said points deposited into said recipient account;
a redemption module configured for enabling said recipient-user to purchase available goods and services by using said points in said recipient account; and
a fulfillment module configured for coordinating and fulfilling said purchase of available goods and services for said recipient-user.

2. The system of claim 1, wherein said account creation module is further configured for receiving from said giver-user contact information associated with said recipient-user.

3. The system of claim 1, further comprising a goods and services database configured for storing said available goods and services.

4. The system of claim 1, wherein said available goods and services vary based on geographic location of said recipient-user.

5. The system of claim 1, wherein said goods and services include at least one of concierge, meal delivery, lawn care, insurance, financial, legal, house cleaning, maintenance mid repairs, transportation, organizing, child care, senior care, and other services.

6. The system of claim 1, further comprising an account management module configured to automatically transfer points from said recipient account that have aged for 23 months.

7. The system of claim 1, further comprising an account management module configured to automatically transfer points from said recipient account that have aged for 24 months or longer.

8. A method for enabling the purchase and distribution of goods and services between a giver-user and recipient-user, said method comprising the steps of:
receiving a request from said giver-user to purchase points as a gift for a recipient-user;
determining whether information provided with said request matches an existing recipient account for said recipient-user, and if no match is found, creating a new recipient account for said recipient-user and notifying said recipient-user of said new recipient account;
requesting from said giver-user a point amount to purchase as a gift for said recipient-user;
depositing said purchased point amount into said recipient account for said recipient-user;
determining whether said giver-user desires to share said recipient account for said recipient-user with other potential givers, and if said giver-user requests to share said recipient account, creating a link to said recipient account for said giver-user;
providing said recipient-user access to said recipient account;
providing an online dashboard within said recipient account to enable said recipient-user to view said points within said recipient-account;
providing a list of available goods and/or services to said recipient-user;
receiving a request to purchase one or more goods and/or services from said recipient-user;
notifying a provider of said requested goods and/or services;
fulfilling said request for goods and/or services to said recipient-user; and
deducting points from said recipient account associated with said request for goods and/or services.

9. The method of claim 8, further comprising the step of receiving from said giver-user contact information for said recipient-user.

10. The method of claim 8, wherein said list of available goods and/or services is defined by a geographical location of said recipient-user.

11. The method of claim 8, wherein said step of receiving a request from said recipient-user for goods and/or services includes requesting a delivery date and location for said goods and/or services.

12. The method of claim 8, wherein said available goods and/or services includes at least one of concierge, meal delivery, lawn care, insurance, financial, legal, house cleaning, maintenance and repairs, transportation, organizing, child care, and senior care.

13. The method of claim 8, wherein points in said recipient account will be deposited into an administrative account upon the points in said recipient account having aged for 23 months without redemption by said recipient-user.

14. The method of claim 8, wherein points in said recipient account will be deposited into an administrative account upon the points in said recipient account having aged for 24 months with redemption by said recipient-user.
